(19) United States
(12) Patent Application Publication
(10) Pub. No.: US 2008/0263578 A1
(43) Pub. Date: Oct. 23, 2008

(54) Forecasting TV Impressions

(75) Inventors: Jason Bayer, Mountain View, CA (US); Greg Hecht, Mountain View, CA (US); Daniel J. Zigmond, Menlo Park, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/692,811

(22) Filed: Mar. 28, 2007

(51) Int. Cl. H04N 7/025; H04H 60/33; H04N 5/445; H04N 7/16

(52) U.S. Cl. 725/9; 725/23; 725/34; 725/46; 705/14

(57) ABSTRACT

A computer-implemented method for forecasting television impressions comprises receiving information relating to previous television (TV) impressions at a time slot on a TV channel, information relating to one or more programs shown at the time slot on the TV channel and predicting a future TV impression at the time slot on the TV channel. The future TV impression is based on at least one of the information related to previous TV impressions and the information related to programs shown at the time slot on the TV channel.

### TECHNICAL FIELD

In general, this document describes predicting television impressions.

### BACKGROUND

Television (TV) continues to remain one of the most popular media for information and entertainment despite the growing popularity of and technical advancements in other media such as the internet, radio, podcasts, and the like. Content shown for display on TV (via conventional airwaves, cable and/or satellite) reaches a very large audience. Advertisers rely extensively on TV to expose the audience to their products and services through advertisements. TV channels and networks, in turn, rely extensively on advertisers to generate revenue.

Content shown on TV is distributed across several channels. In some cases, all content shown by a channel is related to a common theme. For example, Food Network is a cable channel that shows content related to food. In other cases, a channel shows a variety of content, each piece of content geared toward one or more sub-sets of audience within the general audience. For example, some of the TV shows shown by the National Broadcasting Company (NBC) may be designed for a demographic of 18-25 year old women.

Information pertaining to the number of viewers of the content shown on TV (the impressions), the genre of the content, the time slot when the content is shown, and the like, is vital to an advertiser in choosing an appropriate time to show an advertisement. For example, an advertiser might prefer that an advertisement related to a motorcycle dealership be presented during an episode of American Choppers (a show about custom motorcycle building) to reach the maximum target audience and, therefore, have maximum impact.

For a telecast provider, the financial incentive to create popular content for TV is to attract advertisers. For an advertiser, paying a TV station to present an advertisement is an effective investment only to the extent that the advertisement reaches the advertiser's target audience. Advertisers whose products and services are limited to a relatively small geographic region tend to prefer that telecast providers present advertisements related to their products and services at times when target audiences living in that area are viewing TV Also, viewers tend to be interested only in advertisements relevant to their requirements and interests.

### SUMMARY

In one aspect, a computer-implemented method of forecasting television impressions includes receiving information relating to previous television (TV) impressions at a time slot on a TV channel and information relating to one or more programs shown at the time slot on the TV channel, and predicting a future TV impression at the time slot on the TV channel, wherein the future TV impression is based on at least one of the information related to previous TV impressions and the information related to programs shown at the time slot on the TV channel.

These and other aspects can include one or more of the following features. The method can further include selecting an advertisement predicted to generate the future TV impression when presented at the predicted time slot on the predicted TV channel. The advertisement can be selected from an advertisement inventory including a plurality of advertisements. The advertisement inventory can include metadata related to the content of the advertisement and a target audience to which the advertisement is directed. Selecting the advertisement can include selecting the advertisement based on the metadata and the target audience. The method can further include receiving the plurality of advertisements from one or more advertisers. The method can further include transmitting the selected advertisement, the predicted time slot, and the predicted TV channel to a telecast provider. The method can further include presenting the selected advertisement at the predicted time slot on the predicted TV channel. The information related to previous TV impressions can include a number of viewers that were viewing TV at the time slot, and a TV channel that each viewer was viewing. The method can further include obtaining the number of viewers and the TV channel from the viewer. The information related to previous TV impressions can further include a number of TVs that were turned on at the time slot, and a channel that the TVs were tuned to at the time slot. The method can further include collecting the number of TVs and the channel from devices configured to provide TV services to a TV. The method can further include obtaining the information related to previous TV impressions from a telecast provider providing TV services to the viewers. The method can further include augmenting the information related to previous TV impressions by information obtained from an external source. The method can further include collecting the information related to previous TV impressions over a plurality of past weeks. The information related to programs can include one or more of a listing of a plurality of TV channels, a schedule of content shown on each TV channel, a genre of the content, and advisory information related to the content. The method can further include obtaining the information from an external source. The schedule can include past schedules and future schedules. The predicting can include processing the received previous TV impressions by a statistical technique, wherein the statistical technique accounts for a state of content in a future showing at the time slot on the TV channel. The statistical technique can account for a state of content in a future showing at the time slot on the TV channel. The method can further include averaging the received previous TV impressions. The method can further include determining the state by factors including one or more of new content, rerun of old content, a special event, and content shown on other TV channels. The method can further include receiving a previous TV impression at the time slot on the TV channel, comparing the received TV impression to the predicted TV impression, and adjusting future predictions based on the comparison.

In another aspect, a system for forecasting television impressions can include an advertisement decision engine configured to receive information relating to previous television (TV) impressions at a time slot on a TV channel and information relating to one or more programs shown at the time slot, and predict a future TV impression at the time slot on the TV channel, wherein the future TV impression is based on at least one of the information related to previous TV impressions and the information related to programs shown at the time slot on the TV channel.

These and other aspects can include one or more of the following features. The advertisement decision engine can be further configured to select an advertisement, wherein the selected advertisement is predicted to generate the future TV impression when presented at the predicted slot on the predicted TV channel. The advertisement decision engine can include an advertisement inventory that can include a plurality of advertisements from which the advertisement can be selected. The advertisement inventory can include metadata related to the content of the advertisement and a target audience to which the advertisement is directed. The advertisement decision engine can select the advertisement based on the metadata and the target audience. The plurality of advertisements can be received from one or more advertisers. The advertisement decision engine can be configured to transmit the selected advertisement, the predicted time slot, and the predicted TV channel to a telecast provider. The telecast provider can present the selected advertisement at the predicted time slot on the predicted TV channel. The information related to previous TV impressions can include a number of viewers that were viewing TV at the time slot, and a TV channel that each viewer was viewing. The number of viewers and the TV channel can be obtained from the viewer. The information related to previous TV impressions can further include a number of TVs that were turned on at the time slot, and a channel that the TVs were tuned to at the time slot. The number of TVs and the channel can be obtained from devices configured to provide TV services to a TV. The information related to previous TV impressions can be collected by a telecast provider providing TV services to the viewers. The information related to previous TV impressions can be augmented by information obtained from an external source. The information related to previous TV impressions can be collected over a plurality of past weeks. The information related to programs can include one or more of a listing of a plurality of TV channels, a schedule of content shown on each TV channel, a genre of the content, and advisory information related to the content. The listing and the schedule can be obtained from an external source. The information can include past schedules and future schedules. The advertisement decision engine can be configured to predict by processing the received previous TV impressions by a statistical technique, wherein the statistical technique accounts for a state of content in a future showing at the time slot on the TV channel. The statistical technique can include averaging the received previous TV impressions. The state can be determined by factors including one or more of new content, rerun of old content, a special event, and content shown on other TV channels. The advertisement decision engine can further be configured to receive a previous TV impression at the time slot on the TV channel, compare the received TV impression to the predicted TV impression, and adjust future predictions based on the comparison.

In another aspect, a system includes means for receiving information relating to previous television (TV) impressions at a time slot on a TV channel, and information relating to one or more programs shown at the time slot, and means for predicting a future TV impression at the time slot on the TV channel, wherein the future TV impression is based on at least one of the information related to previous TV impressions and the information related to programs shown at the time slot on the TV channel.

These and other aspects can include one or more of the following features. The system can include means for selecting an advertisement, wherein the selected advertisement is predicted to generate the future TV impression when presented at the predicted time slot on the predicted TV channel. The system can include means for storing a plurality of advertisements from which the advertisement is selected. The means for storing can include metadata related to the content of the advertisement and a target audience to which the advertisement is directed. Selecting the advertisement can include selecting the advertisement based on the metadata and the target audience. The plurality of advertisements can be received from one or more advertisers. The system can be configured to transmit the selected advertisement, the predicted time slot, and the predicted TV channel to a telecast provider. The telecast provider can present the selected advertisement at the predicted time slot on the predicted TV channel. The information related to previous TV impressions can include a number of viewers that were viewing TV at the time slot, and a TV channel that each viewer was viewing. The number of viewers and the TV channel can be obtained from the viewer. The information related to previous TV impressions can further include a number of TVs that were turned on at the time slot and a channel that the TVs were tuned to at the time slot. The number of TVs and the channel can be obtained from devices configured to provide services to a TV The information related to previous TV impressions can be collected by a telecast provider providing TV services to the viewers. The information related to previous TV impressions can be augmented by information obtained from an external source. The information related to previous TV impressions can be collected over a plurality of past weeks. The information related to programs can include one or more of a listing of a plurality of TV channels, a schedule of content shown on each TV channel, a genre of the content, and advisory information related to the content. The listing and the schedule can be obtained from an external source. The information can include past schedules and future schedules. The means for predicting can be configured to predict by processing the received previous TV impressions by a statistical technique, wherein the statistical technique can account for a state of content in a future showing at the time slot on the TV channel. The statistical technique can include averaging the received previous TV impressions. The state can be determined by factors including one or more of new content, rerun of old content, a special event, and content shown on other TV channels. The system can further include means for receiving a previous TV impression at the time slot on the TV channel, means for comparing the received TV impression to the predicted TV impression, and means for adjusting future predictions based on the comparison.

In one example, the system and techniques described here can be used to predict the impressions during a time slot on a channel, provide an advertisement to the telecast provider to be presented during the predicted time slot on the channel based on a target audience specified by an advertiser, receive data related to actual impressions collected once the advertisement is presented, and use the collected data to improve future predictions. The system and techniques described here may present one or more of the following advantages. The ability to predict the impressions during a time slot on a channel can enable advertisers to choose the time and channel on which to present an advertisement to maximize targeting. Further, being able to predict the number of viewers that will be watching TV at a given time on a given channel can allow advertisers to estimate the value of advertisements. If advertisers possess data related to the size of the audience that may potentially view their advertisement, they can decide whether the investment on advertising is worth the return. In addition, by collecting actual data related to the impressions during a time slot on a channel, future predictions of the number of impressions can be based more on actual data and less on speculation. Moreover, advertisers can be provided with options regarding time slots and channels to present advertisements. Based on the options, advertisers can present advertisements based on criteria including size of the audience, time of the day and day of the week, and specific demographic. Such options can include time slots that can bring in a high number of impressions to the advertisers.

Furthermore, a centralized system that stores advertisements can allow telecast providers to choose advertisements relevant to themed TV channels. This can enable telecast providers to generate more revenue for content shown on themed TV channels since the audience of such channels will be interested in relevant advertisement, which, in turn, can encourage advertisers to pay to show the relevant advertisements on the themed channels. Further, small advertisers who do not have access to telecast providers can use the centralized system to be automatically matched with appropriate telecast providers. In addition, the possibility of a TV viewer being presented advertisements that are relevant to the viewer's interest can be enhanced.

The details of one or more implementations are set forth in the accompanying drawings and the description below. Other features and advantages will be apparent from the description and drawings, and from the claims.

### DESCRIPTION OF DRAWINGS

FIG. 1 shows an example of an advertisement decision system.

FIG. 2 shows an example of an advertisement decision engine.

FIG. 3 shows an example of a prediction system that can be used to predict impressions, time slots, and channels.

FIG. 4 is a flow chart of an example of a process of predicting impressions.

FIG. 5 is a flow chart of an example of a process of predicting a time slot on a channel to present an advertisement.

FIG. 6 shows an example of an advertisement decision engine.

Like reference symbols in the various drawings indicate like elements.

### DETAILED DESCRIPTION

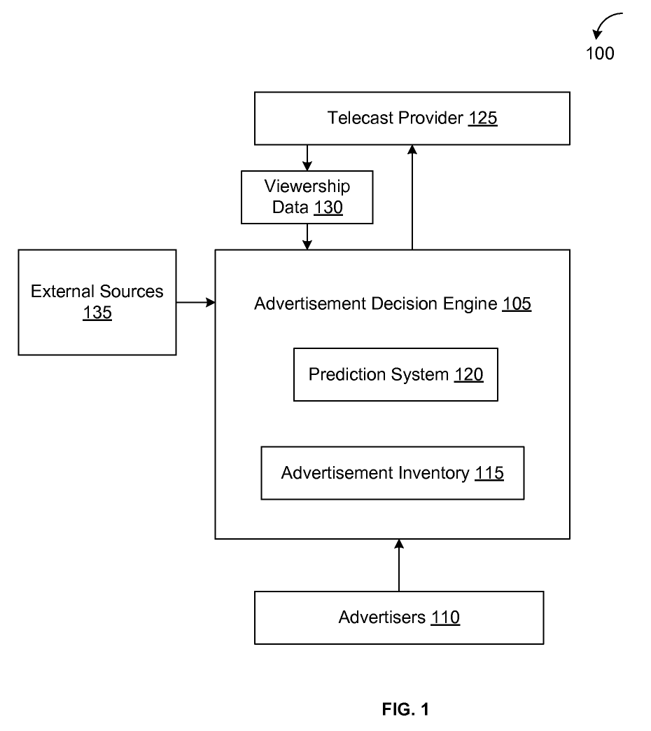

FIG. 1 depicts an example of a schematic of an advertisement decision system 100. The system 100 includes an advertisement decision engine (ADE) 105. In some implementations, the ADE 105 is configured to receive input from advertisers 110. The input includes content to be presented as advertisements and information related to the advertisements. The input from the advertisers 110 is stored in an advertisement inventory 115. In other implementations, the advertisement inventory 115 can be stored external to the ADE 105, configured to receive input from advertisers 110, and be operatively coupled to the ADE 105. The information related to the advertisements can include targeting information about the target audience that the advertisers wish to reach and, optionally, restrictions on times when and channels on which to present the advertisements.

The ADE 105 includes a prediction system 120. The prediction system 120 utilizes input including information gathered by a telecast provider 125 and input received from an advertiser 110 which is stored in the advertisement inventory 115. The information gathered by a telecast provider 125 can include measurement of viewership such as user-activity logs in the form of viewership data 130. The viewership measurement can include account information of the viewing household, for example, zip code, phone prefix, occupations, average income, and the like. In some implementations, the ADE 105 can pull the information from data collected by the telecast provider 125. In other implementations, the ADE 105 can provide fields that can be used by the prediction system 120 to the telecast provider 125. The telecast provider 125 can select the values for the fields provided by the ADE 105 and push the information to the ADE 105.

In addition, the ADE 105 can also receive information including the menu and timings of all content shown on all channels carried by the telecast provider 125. The information can include timings for content such as episodes of TV shows, reruns of the TV shows, special events (e.g., Super Bowl, Oscars, and the like), new shows, and the like. The information can include whether the TV channels shown by the provider 125 are network channels or cable channels. The information can include specific requests requesting advertisements related to one or more specific themes that can be presented in channels that present content related to the themes. In some implementations, the additional information can be received from one or more external sources 135, e.g., Nielsen Media Research, Tribune Media Services, and the like.

The viewership data 130 can include previous impressions during one or more time slots on one or more channels that were gathered over a period of time. The viewership data 130 can include, for each TV channel carried by the telecast provider 125, the previous impressions, such as the number of viewers of a TV show, on a channel at a given time on a given day for as many number of days as the telecast provider 125 collected data. The viewership data 130 can further include the demographic of viewers at different time periods of a day on each day of the week. The viewership data 130 can also include future program schedules. The viewership data 130 can also include behavioral patterns of viewers, for example, buying habits, hobbies, interests, and the like.

Based on the input from the telecast provider 125, the prediction system 120 can predict the future impressions during time slots on channels. Further, based on information related to an advertisement stored in the advertisement inventory 115, the ADE 105 can identify advertisements and chooses time slots on channels to present the advertisements. In this manner, the ADE 105 can predict the future impressions that an advertisement will be exposed to if presented at the predicted time slot on the predicted channel. In some implementations, the ADE 105 can transmit the advertisement to the telecast provider 125 for presentation during the predicted time slots on the predicted channels. In other implementations, the ADE 105 can present the predicted time slot and the channel to an advertiser 110. The advertiser 110 can optionally accept or reject the time slot and the channel and change the targeting criteria. The ADE 105 can, subsequently, predict a new time slot and a new channel based on the new criteria. The telecast provider 125 gathers data related to the actual impressions during all time slots on all channels. The telecast provider 125 provides the gathered data to the ADE 105. The ADE 105 compares the predicted and actual impressions and uses any variations to improve future predictions of impressions by the prediction system 120.

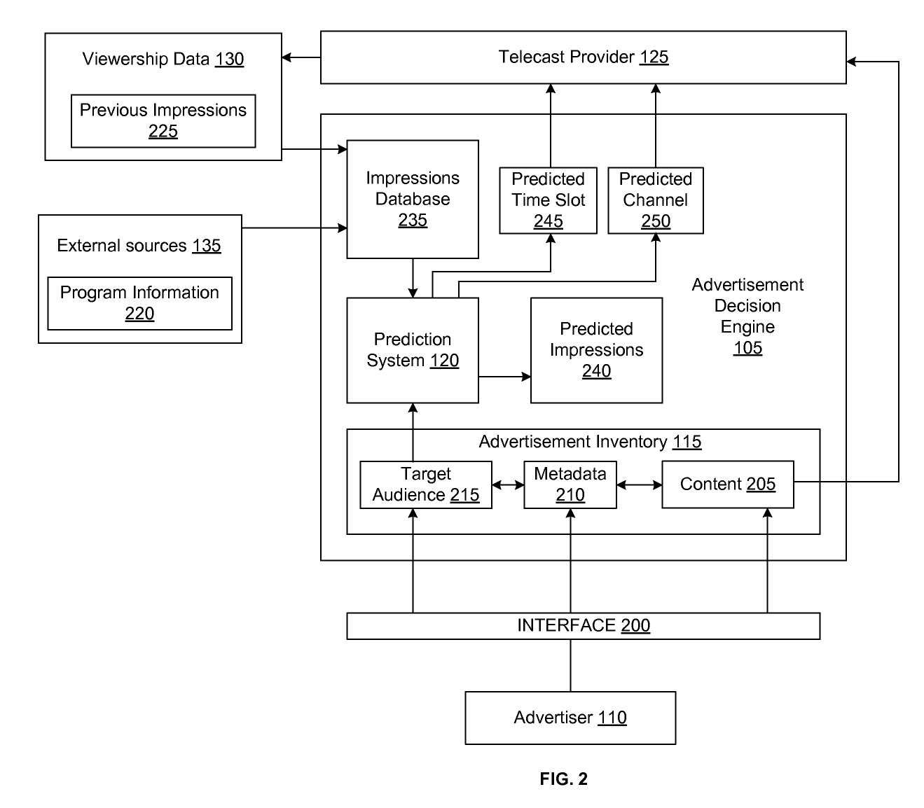

FIG. 2 depicts an example of a schematic of an advertisement decision engine (ADE) 105. The ADE 105 receives advertisements as input from advertisers 110 via an interface 200. In some implementations, the advertisements are stored in an advertisement inventory 115. The advertisements can include content 205, which is the content viewed on TV when an advertisement is presented. In addition, the advertisement can include related metadata 210 which indicates the nature of the content 205 in the advertisement. For example, an advertisement for an automobile may include a video clip of the automobile being driven as content. The metadata 210 related to the content can include information provided by the advertiser 110 indicating that the advertisement is, in general, related to automobiles, and, in specific, related to a specific make and model of a specific automobile brand. The advertisement can also include target audience 215 specified by the advertiser 110. For example, the advertiser 110 may wish the automobile advertisement to be presented to a demographic of 18-30 year olds.

In some implementations, the advertisement inventory 115 can be included in the ADE 105. In other implementations, the advertisement inventory 115 can be located external to the ADE 105 and can be operatively coupled to communicate with the ADE 105. In some implementations, the advertiser 110 can provide only the content 205. The ADE 105 can be configured to search the content 205 and determine the nature of the advertisement. Based on this determination, the ADE 105 can be configured to determine a target audience 215. The ADE 105 can compare the content 205 of the received advertisement with the content 205 of advertisements stored in the advertisement inventory 115 to determine the target audience 215. In other implementations, the ADE 105 can receive content 205 and related metadata 210. The ADE 105 can compare the metadata 210 to the metadata 210 of advertisements stored in the advertisement inventory 115 and use the result of the comparison to identify a target audience 215 for the advertisement. For example, based on metadata 210, the ADE 105 can identify an advertisement for a car, another advertisement for a truck, and recognize that both identified advertisements are related to automobiles.

The ADE 105 is operatively coupled to send advertisements to and receive data from a telecast provider 125. The data from the telecast provider 125 is received via viewership data 130. In some implementations, the viewership data 130 can include previous impressions 225, for example, impressions 225 collected during time slots on channels. In some implementations, previous impressions 225 can include the number of viewers that watched the content shown on a channel at a given time. The telecast provider 125 may obtain this information by selecting a representative group of viewers from within the provider's area of coverage and requesting viewers of the group to record their TV viewing habits. In this manner, the telecast provider 125 may obtain the impressions of the representative group. The telecast provider 125 may subsequently extrapolate the TV viewing habits of this representative group to predict the viewing habits of all viewers within the telecast provider's area of coverage.

In other implementations, previous impressions 225 can include the number of TVs that were turned on during a given time and tuned to a given channel. A telecast provider 125 may obtain this information by monitoring the set top boxes and similar devices installed in locations where TV showing is provided. These devices may monitor times and durations when a viewer's TV is turned on and the channels that the TV is tuned to. In addition, the devices may also monitor times and durations when a viewer's recording instrument, such as digital video recorder (DVR), is turned on. This data may be transmitted back to the telecast provider 125 for subsequent transmission to viewership data 130 for storage under previous impressions 225. Alternatively, or in addition, the data may be transmitted directly to viewership data 130 for storage under previous impressions 225.

In some implementations, the ADE 105 can be operatively coupled to receive information from external sources 135. The external sources 135 can include program information 220, including electronic programming guides. The electronic programming guides can provide information related to content being shown and the time when the content is being shown. The program information 220 can include additional information related to the content, for example, genre, category, advisory information about the content, and the like. Such additional information can also be collected by sources such as Tribune Media Services. The ADE 105 can be configured to map the content to a demographic of viewers that are likely to view the content based on the program information 220. For example, the electronic program guides can provide information related to cartoon shows and a time for presenting the cartoon shows. Based on program information 220 obtained from external sources 135, the ADE 105 can identify that the genre of content is preferable for children. The ADE 105 can identify that a preferred time to show cartoon shows can be late afternoon after schools have closed for the day. Accordingly, the ADE 105 may choose late afternoon to present advertisements related to toys.

In some implementations, the program information 220 collected by external sources 135 can include impression statistics collected by third parties such as Nielsen Media Research and household statistics collected from individual households, and provided to the ADE 105. The channels presenting content can provide the data to the telecast provider 125 and to the external sources 135. The telecast provider 125 and the external sources 135 can transfer the data and the information to the ADE 105.

In other implementations, the ADE 105 can receive previous impressions data from external sources 135 including Nielsen Media Research. While the information collected and stored in viewership data 130 from telecast providers 125 may be representative of the area covered by the telecast provider 125, information from external sources 135 including Nielsen Media Research may provide impressions data collected from a national audience. In some implementations, the data stored in viewership data 130 can be collected from both telecast providers 125 and external sources 135.

The information collected from representative groups of viewers can provide data related to the number of viewers of content. For example, when a TV is viewed by a viewer belonging to the representative group and others, the number of impressions recorded during that time includes the viewer and the others. However, since the representative group does not cover all viewers in a telecast provider's area of coverage, extrapolating the data collected from the representative group to all viewers in the area of coverage can be speculative. Information monitored by set top boxes and similar devices provide data related to the number of TVs that were on, the times when the TVs were on, and the channels that the TVs were tuned to. However, this information does not accurately represent the number of viewers of each TV. The ADE 105 can obtain data from the set-top boxes or both set-top boxes and representative groups, combine this data with similar data collected for a national audience from external sources 135, and predict the number of future impressions during a time slot for any channel.

In some implementations, the data obtained from telecast providers 125 can be used to build a model of the viewing household. For example, upon obtaining permission from viewers, telecast providers 125 may gather supplemental information about the viewers' respective households along with their viewing habits. Such supplemental information can include zip code, telephone information, and the like. The supplemental information can be combined with information obtained from external sources 135 (e.g., Experian) to model the average number of family members in viewers' households, their ages, buying habits, and the like. Such information can also be used to improve targeting and predicting time slots on channels for presenting advertisements.

The information obtained from telecast providers 125 and external sources 135 is input to the ADE 105 and stored in the impressions database 235. The program information 220 and previous impressions 225 can be regularly updated based on input from telecast providers 125 and external sources 135. The program information 220 obtained from TV channels and external sources 135 changes regularly with addition of new content, reruns of old content, special events, and the like. The previous impressions 225 also change in response to changes to the program information and other factors, such as holidays, weather, and the like. The viewership data 130 may receive updates at a frequency decided by the telecast provider 125 and the external sources 135. In some implementations, the viewership data 130 can overwrite the information based on updates received at one frequency and transmit the updated information to the impressions database 235 at a different frequency. In other implementations, the updates can be transmitted to the ADE 105 and the impressions database 235 can be updated at the same frequency with which the updates are received.

The data stored in the impressions database 235 can be input to the prediction system 120 in the ADE 105. Based on the input received from the impressions database 235, the prediction system 120 outputs predicted impressions 240. The predicted impressions 240 is the impressions during a time slot on a channel. In some implementations, the prediction system 120 can predict the number of impressions with a high level of granularity, e.g., the impressions for each channel during each second.

In some implementations, the data in program information 220 and previous impressions 225 can be collected from one or more telecast providers 125 and external sources 135 over a period of time. In predicting the number of impressions at a given time on a given channel, the prediction system 120 can apply statistical techniques, e.g., averaging, to the previous impressions 225 collected for that time at that channel to previously collected data. In addition, the prediction system 120 can factor in program information 220 including new content, reruns of old content, special events, demographic habits, and the like. Upon approval by viewers in the telecast provider's area of coverage, the prediction system 120 may also use a viewer's buying pattern based on a viewer's geographic location as a factor in the prediction system 120. In addition, the prediction system 120 can also use data collected by viewer interaction with the electronic program guides.

In addition to calculating predicted impressions 240, the prediction system 120 can calculate a predicted time slot 245 and a predicted channel 250 to present an advertisement for maximum viewing by a target audience. In some implementations, the prediction system 120 can receive the target audience 215 as input from the advertisement inventory 115. The prediction system 120 can compare data in the impressions database 235 with the metadata 210 and target audience 215 related to an advertisement in the advertisement inventory 215 to predict that, if a chosen advertisement is presented at the predicted time slot 245 on the predicted channel 250, the chosen advertisement would generate the predicted impressions 240. Such predictions can be used by advertisers 110 to decide whether to present their advertisements at the predicted time slot 245 on the predicted channel 250 or not.

In other implementations, the prediction system 120 can predict time slots 245 and channels 250 specific to a target audience 215 specified by the advertiser 110. For such predictions, the prediction system 120 can rely on past measurements of previous impressions 225 as well as program information 220 related to the type of content, the target audience that the content is designed for and the like. In some implementations, the prediction system 120 can include past and future schedules of programs on the TV channel for which impressions are predicted, other TV channels, or both. For example, the prediction system 120 may receive input that a special event is scheduled to be shown on a TV channel. The prediction system 120 can associate a weight to the past impressions of viewers who view the TV channel when incorporating the past impressions in the statistical function to calculate future impressions. The prediction system 120 can use such information to choose advertisements for presentation along with content on channels showing content with a common theme. In some implementations, the prediction system 120 can identify trends in previous impressions 225 and incorporate the trends into the statistical techniques to calculate predicted impressions 240.

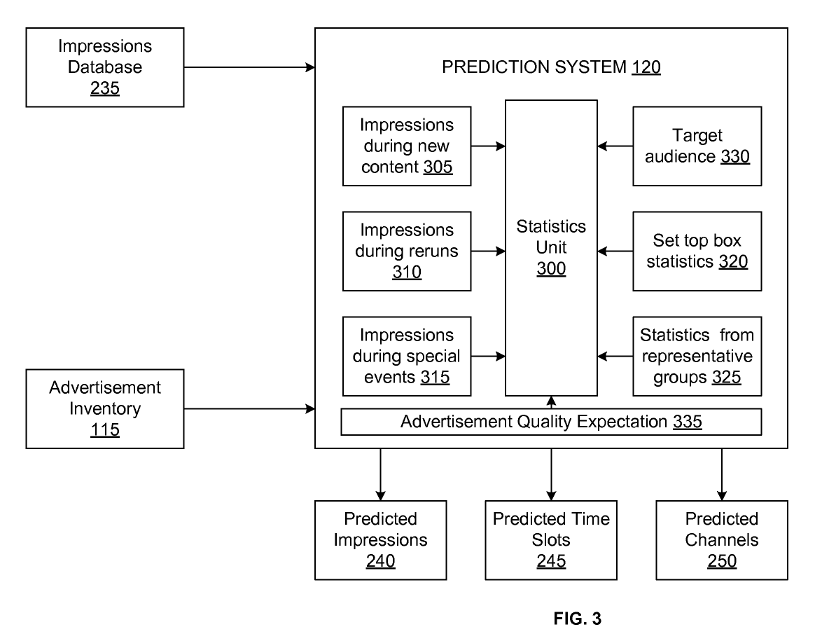

FIG. 3 depicts an example of a schematic of a prediction system 120 to predict impressions 240, time slots 245, and channels 250. The prediction system 120 receives input from the impressions database 235 and the advertisement inventory 115. Input from the impressions database 235 can include impressions collected when the content presented on a channel was new content 305, e.g., a new TV show, a new episode of a weekly TV show, a TV premiere of a movie, and the like. The input can include impressions collected during reruns of content 310 previously shown on TV including content that was presented as new content on one TV channel and subsequently presented on a different channel as a rerun. The input can include impressions collected during special events 315, e.g., Super Bowl, Oscars, Grammies, and the like. The input can include statistics from set top boxes 320 which indicate when a TV was turned on and what channel was being viewed when the TV was turned on. In some implementations, the set top boxes' statistics can be obtained from all TVs serviced by a telecast provider 125. The input can include data obtained from representative groups 325 that include viewers who record their TV viewing habits. The representative groups can include viewers within an area serviced by a telecast provider 125. Data from representative groups outside the telecast provider's area can be obtained from external sources 135 such as Nielsen Media Research. The input can include an advertisement quality expectation 335, which can include the likelihood that viewers view an advertisement or change channels when an advertisement is presented.

In some implementations, the impressions data and the statistics can be collected over a period of time. The predicted impressions 240 can be calculated by statistical techniques including averaging past impressions, collected statistics, and program information. For example, the prediction system 120 can receive input related to impressions and statistics collected for a show on NBC at 8:00 pm on 3 previous Tuesdays. The prediction system 120 can include a statistics unit 300 that can apply a statistical function (e.g., average) to the impressions and statistics from previous weeks to predict the impressions at 8:00 pm on NBC on the following Tuesday. Additionally, the prediction system 120 can receive input that the show on NBC at 8:00 pm on the following Tuesday night is a rerun of a show from 2 weeks before. By factoring this information during calculation, the prediction system 120 can predict that the impressions at 8:00 pm on NBC on the following Tuesday night may be lower than on previous Tuesdays.

In addition, the prediction system 120 can receive an advertisement including input related to target audience 330 for the advertisement from the advertisement inventory 115. The prediction system 120 can predict a time slot and a channel to present the advertisement to reach maximum target audience. In some implementations, the prediction system 120 can predict more than one advertisement to be presented at a time slot on a channel. For example, the content presented on a TV station may have more than one theme or may be of interest to more than one demographic. The prediction system 120 may identify advertisements relevant to the more than one theme and the more than one demographic. The prediction system 120 may specify time gaps between advertisements to maximize targeting. The prediction system 120 may identify content on a channel being sponsored by one advertiser and specify that products of competitors not be presented during that content.

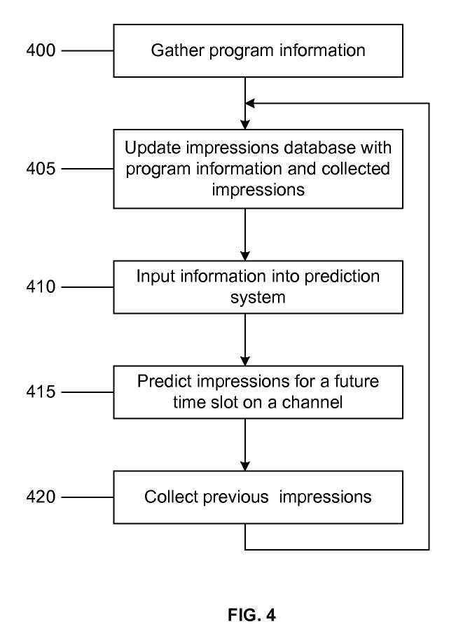

FIG. 4 depicts a flow chart of an example of a process of predicting impressions. In some implementations, program information can be gathered at 400. The program information can be gathered from several sources including telecast providers, TV channels, electronic program guides, external sources such as Nielsen Media Research, and the like. The program information can include TV shows, timings of the TV shows, target demographic, past, present, and future schedules of presentation, new content, rerun content, special events, and the like.

The gathered program information can be stored in the impressions database at 405. In addition, impressions collected from previous time slots can also be included in the impressions database. The collected impressions can include previous impressions for content presented on TV. The collected impressions can be obtained from sources including telecast providers (set top boxes and representative groups), TV channels, external sources such as Nielsen Media Research, and advertisers.

The program information and the collected impressions can be input to the prediction system at 410. In some implementations, the collected data can be input to the prediction system by the sources that collect the data. In some implementations, the data can be collected every second or at a frequency decided by the sources that collect the data. The impressions database can be updated at the same frequency with which the data is collected. In other implementations, the impressions database can be updated at a frequency different from the one at which the data is collected.

Based on the program information and collected impressions, an impression during a future time slot can be predicted at 415. In some implementations, the predicted impressions can be calculated using a statistical function, e.g., by averaging the collected impressions from previous time slots. In other implementations, the statistical function can be influenced by the state of content in a future showing on any TV channel. The states can include new content, rerun of old content, a special event, and content shown on other TV channels. The states can be considered to be factors included in program information that can be included in calculating the predicted impressions. For example, a previously shown content may be a rerun. The showing can be assigned a state to indicate that the showing is a rerun. Impressions collected during that showing may be associated a first weight. Similarly, different weights may be associated to showings of different states. The weights, and other factors, may be included in the calculation of predicted impressions.

Subsequent to predicting the number of impressions for a time slot on a channel, the previous impressions during that time slot on that channel can be collected at 420. The collected impressions data can be used to update the impressions database. The collected impressions data can be used in future calculations of predicted impressions in conjunction with program information. The collected impressions and program information may change regularly. By utilizing the changing impressions and program information collected over a period of time to statistically determine the number of impressions in the future, the difference between predicted and previous impressions can be minimized. Further, based on the collected impressions, the likelihood that viewers will watch an advertisement or will change a channel when an advertisement is presented can also be predicted. In some implementations, the prediction system 120 may identify multiple advertisements for presentation at a time slot on a channel. In such implementations, the prediction system 120 can select a higher-quality advertisement based on the likelihood of viewers changing the channel on which the advertisement is presented.

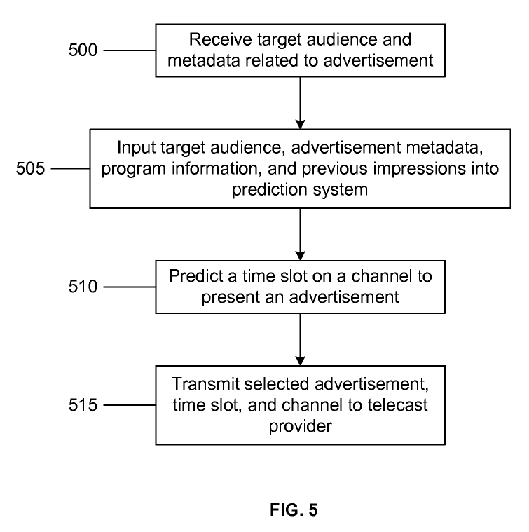

FIG. 5 depicts a flow chart of an example of a process of predicting a time slot on a channel to present an advertisement. In some implementations, advertisements received from the advertiser can be stored in the advertisement inventory. In addition to content to be presented, the advertisement received from an advertiser can include metadata describing the nature of the advertisement, the product being advertised, and the like. In addition, the advertisement can include the target audience that the advertiser wishes to advertise to. The target audience and the metadata provided by the advertiser are received at 500.

The target audience, advertisement metadata, program information, and collected impressions can be input to the prediction system at 505. Based on the input, not only the number of impressions for a time slot on a channel, but also a time slot and a channel to present an advertisement such that the advertisement may be viewed by the advertisement's target audience can be predicted (510). The demographic of the audience based on the collected impressions and program information at that time slot on that channel can also be identified. The identified demographic for the advertisement can match the target audience desired by the advertiser. Subsequently, the target audience can be matched with a time slot on a channel when the target audience views TV In this manner, the target audience for a given advertisement that will view the advertisement if presented at the predicted time slot on the predicted channel can be predicted. The selected advertisement, the predicted time slot, and the predicted channel can be transmitted to the telecast provider at 515. In some implementations, the predicted time slot and channel can be presented to an advertiser. An advertiser may, optionally, accept or reject the time slot and the channel. If an advertiser rejects the selection of the prediction system 120, the targeting parameters can be changed and a new time slot and channel can be predicted.

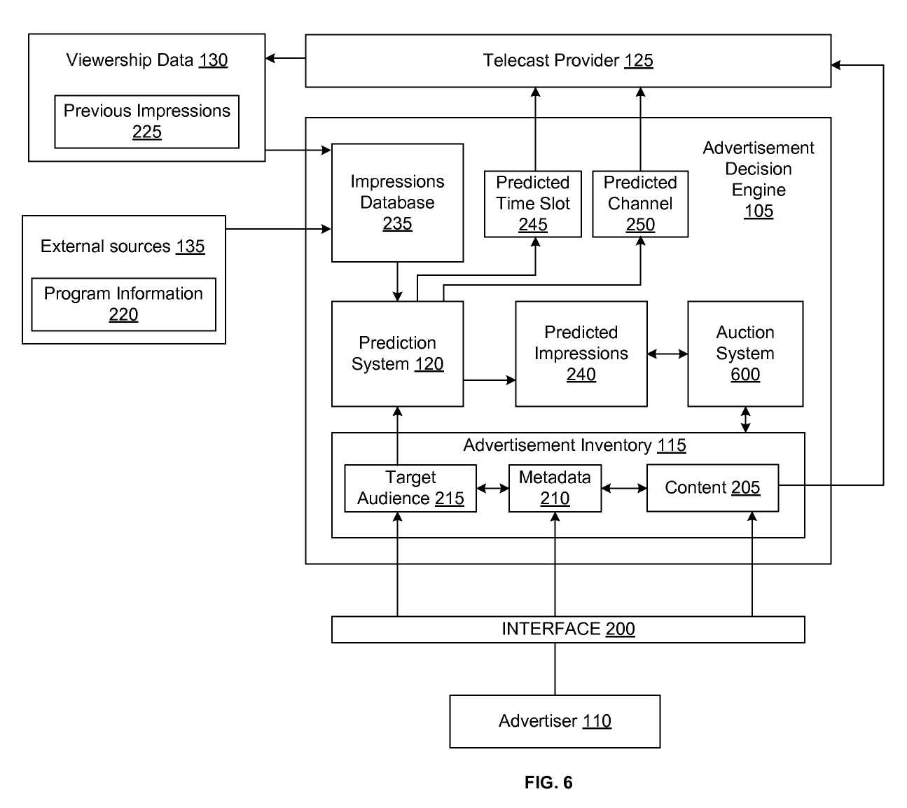

A number of implementations have been described. Nevertheless, it will be understood that various modifications may be made without departing from the spirit and scope of this descriptions. For example, the advertisement decision engine 105 can include an auction system 600 (FIG. 6). The advertisement inventory 115 may include a plurality of advertisements from more than one advertiser related to products and services with similar target audiences. The prediction system 120 can calculate predicted impressions 240 for a particular demographic, e.g., 18-25 year old women. The prediction system 120 can also identify a predicted time slot 245 when the identified demographic will be viewing TV. The prediction system 120 can also identify the predicted channel 250 that the identified demographic will be viewing.

Subsequently, the ADE 105 may identify a plurality of advertisements from the advertisement inventory 115 where the target audience 215 of the identified advertisements match the demographic identified by the prediction system 120. The ADE 105 may present the predicted impressions 240 corresponding to the predicted time slot 245 and the predicted channel 250 to the advertisers 110. The advertisers may present a bid for the amount they are willing to pay to present their advertisements 110 at the predicted time slot 245 on the predicted channel 250. The auction system 600 may collect the bids from all the advertisers and identify the advertiser with the best bid. In some implementations, the bid may be based on each impression (cost per impression, CPI). In other implementations, the bid may be based on every 1000 impressions (cost per mille, CPM).

In some implementations, the advertisement corresponding to the advertiser 110 with the best bid is presented at the predicted time slot 245 on the predicted channel 250. In other implementations, at the end of the auction, the bids may be arranged in decreasing order and the advertisements corresponding to the decreasing order of bids may be presented either before or after the time slot on the same channel. In some implementations, the auction may be conducted as close to the time slot as possible.

In some implementations, the advertisement inventory 115 may store only metadata 210 and target audience 215 related to an advertisement. The content of the advertisement may be stored at the telecast provider's location. The advertisement stored in the advertisement inventory 115 in the ADE 105 may be assigned an identification (ID) that corresponds to the identification (ID) assigned to the content 205 of the advertisement at the telecast provider's location. When an advertisement is identified for presentation at a time slot on a channel, the ADE 105 may communicate the ID to the telecast provider 125. The telecast provider 125 may present the corresponding content 205 of the advertisement at the identified time slot on the identified channel.

In some implementations, the advertisements presented by an advertiser 110 through an interface described in the patent titled “Methods and apparatus for serving relevant advertisements,” (US Patent Application Publication No. 204/0059708 A1, publication date Mar. 25, 2004), the contents of which are incorporated by reference here. The advertisements may be stored in the AdWords database. The advertiser may specify presenting the advertisements on all types of media, such as the internet, TV, radio, and the like, for maximum exposure. Advertisements containing video content may be selected from the AdWords database and transferred to the ADE 105. In other implementations, advertisements containing video content may be selected from the AdWords database and transferred to the telecast provider 125. In this manner, advertisements containing video content may be presented on the internet, on TV, and other similar visual media. In some implementations, an advertiser may specify presenting an advertisement specifically for TV.

The prediction system 120 may be used to predict the number of listeners and the demographic of listeners on radio stations. The prediction system 120 may predict a time slot on a radio channel to present an advertisement such that the advertisement is heard by maximum listeners of the target audience. Audio-based advertisements may be received using the AWFE. Audio portions of advertisements designed for presentation on TV may be presented during the predicted time slots on the predicted radio channels. Accordingly, other implementations are within the scope of the following claims.

What is claimed is:

1. A computer-implemented method of forecasting television impressions, comprising:
receiving
(a) information relating to previous television (TV) impressions at a time slot on a TV channel, and
(b) information relating to one or more programs shown at the time slot on the TV channel; and
predicting a future TV impression at the time slot on the TV channel, wherein the future TV impression is based on at least one of the information related to previous TV impressions and the information related to programs shown at the time slot on the TV channel.

2. The method of claim 1, further comprising selecting an advertisement predicted to generate the future TV impression when presented at the predicted time slot on the predicted TV channel.

3. The method of claim 2, wherein the advertisement is selected from an advertisement inventory comprising a plurality of advertisements.

4. The method of claim 3, wherein the advertisement inventory comprises metadata related to the content of the advertisement and a target audience to which the advertisement is directed.

5. The method of claim 4, wherein selecting the advertisement comprises selecting the advertisement based on the metadata and the target audience.

6. The method of claim 3, further comprising receiving the plurality of advertisements from one or more advertisers.

7. The method of claim 2, further comprising transmitting the selected advertisement, the predicted time slot, and the predicted TV channel to a telecast provider.

8. The method of claim 7, further comprising presenting the selected advertisement at the predicted time slot on the predicted TV channel.

9. The method of claim 1, wherein the information related to previous TV impressions comprises:
a number of viewers that were viewing TV at the time slot; and
a TV channel that each viewer was viewing.

10. The method of claim 9, further comprising obtaining the number of viewers and the TV channel from the viewer.

11. The method of claim 9, wherein the information related to previous TV impressions further comprises:
a number of TVs that were turned on at the time slot; and
a channel that the TVs were tuned to at the time slot.

12. The method of claim 11, further comprising obtaining the number of TVs and the channel from devices configured to provide TV services to a TV.

13. The method of claim 9, further comprising obtaining the information related to previous TV impressions from a telecast provider providing TV services to the viewers.

14. The method of claim 13, further comprising augmenting the information related to previous TV impressions by information obtained from an external source.

15. The method of claim 1, further comprising collecting the information related to previous TV impressions over a plurality of past weeks.

16. The method of claim 1, wherein the information related to programs comprises one or more of a listing of a plurality of TV channels, a schedule of content shown on each TV channel, a genre of the content, and advisory information related to the content.

17. The method of claim 16, further comprising obtaining the information from an external source.

18. The method of claim 17, wherein the schedule comprises past schedules and future schedules.

19. The method of claim 1, wherein the predicting comprises processing the received previous TV impressions by a statistical technique, wherein the statistical technique accounts for a state of content in a future showing at the time slot on the TV channel.

20. The method of claim 19, further comprising averaging the received previous TV impressions.

21. The method of claim 19, further comprising determining the state by factors including one or more of new content, rerun of old content, a special event, and content shown on other TV channels.

22. The method of claim 1, further comprising:
receiving a previous TV impression at the time slot on the TV channel;
comparing the received TV impression to the predicted TV impression; and
adjusting future predictions based on the comparison.

23. A system for forecasting television impressions, comprising:
an advertisement decision engine comprising:
an advertisement inventory configured to receive information relating to previous television (TV) impressions at a time slot on a TV channel; and
an impressions database configured to receive information relating to one or more programs shown at the time slot,
wherein the advertisement decision engine is configured to predict a future TV impression at the time slot on the TV channel, wherein the future TV impression is based on at least one of the information related to previous TV impressions and the information related to programs shown at the time slot on the TV channel.

24. The system of claim 23, wherein the advertisement decision engine is further configured to select an advertisement, wherein the selected advertisement is predicted to generate the future TV impression when presented at the predicted time slot on the predicted TV channel.

25. The system of claim 24, wherein the advertisement decision engine comprises an advertisement inventory comprising a plurality of advertisements from which the advertisement is selected.

26. The system of claim 25, wherein the advertisement inventory comprises metadata related to the content of the advertisement and a target audience to which the advertisement is directed.

27. The system of claim 26, wherein the advertisement decision engine selects the advertisement based on the metadata and the target audience.

28. The system of claim 25, wherein the plurality of advertisements are received from one or more advertisers.

29. The system of claim 24, wherein the advertisement decision engine is configured to transmit the selected advertisement, the predicted time slot, and the predicted TV channel to a telecast provider.

30. The system of claim 29, wherein the telecast provider presents the selected advertisement at the predicted time slot on the predicted TV channel.

31. The system of claim 23, wherein the information related to previous TV impressions comprises:
a number of viewers that were viewing TV at the time slot; and
a TV channel that each viewer was viewing.

32. The system of claim 31, wherein the number of viewers and the TV channel are obtained from the viewer.

33. The system of claim 31, wherein the information related to previous TV impressions further comprises:
a number of TVs that were turned on at the time slot; and
a channel that the TVs were tuned to at the time slot.

34. The system of claim 33, wherein the number of TVs and the channel is obtained from devices configured to provide TV services to a TV.

35. The system of claim 31, wherein the information related to previous TV impressions is collected by a telecast provider providing TV services to the viewers.

36. The system of claim 35, wherein the information related to previous TV impressions is augmented by information obtained from an external source.

37. The system of claim 23, wherein the information related to previous TV impressions is collected over a plurality of past weeks.

38. The system of claim 23, wherein the information related to programs comprises one or more of a listing of a plurality of TV channels, a schedule of content shown on each TV channel, a genre of the content, and advisory information related to the content.

39. The system of claim 38, wherein the listing and the schedule is obtained from an external source.

40. The system of claim 38, wherein the information comprises past schedules and future schedules.

41. The system of claim 23, wherein the advertisement decision engine is configured to predict by processing the received previous TV impressions by a statistical technique, wherein the statistical technique accounts for a state of content in a future showing at the time slot on the TV channel.

42. The system of claim 41, wherein the statistical technique comprises averaging the received previous TV impressions.

43. The system of claim 41, wherein the state is determined by factors including one or more of new content, rerun of old content, a special event, and content shown on other TV channels.

44. The system of claim 23, the advertisement decision engine further configured to:
receive a previous TV impression at the time slot on the TV channel;
compare the received TV impression to the predicted TV impression; and
adjust future predictions based on the comparison.

45. A system comprising:
means for receiving
(a) information relating to previous television (TV) impressions at a time slot on a TV channel, and
(b) information relating to one or more programs shown at the time slot; and
means for predicting a future TV impression at the time slot on the TV channel, wherein the future TV impression is based on at least one of the information related to previous TV impressions and the information related to programs shown at the time slot on the TV channel.

46. The system of claim 45, further comprising means for selecting an advertisement, wherein the selected advertisement is predicted to generate the future TV impression when presented at the predicted time slot on the predicted TV channel.

47. The system of claim 46, further comprising means for storing a plurality of advertisements from which the advertisement is selected.

48. The system of claim 47, wherein the means for storing comprises metadata related to the content of the advertisement and a target audience to which the advertisement is directed.

49. The system of claim 48, wherein selecting the advertisement comprises selecting the advertisement based on the metadata and the target audience.

50. The system of claim 47, wherein the plurality of advertisements are received from one or more advertisers.

51. The system of claim 46, configured to transmit the selected advertisement, the predicted time slot, and the predicted TV channel to a telecast provider.

52. The system of claim 51, wherein the telecast provider presents the selected advertisement at the predicted time slot on the predicted TV channel.

53. The system of claim 45, wherein the information related to previous TV impressions comprises:
a number of viewers that were viewing TV at the time slot; and
a TV channel that each viewer was viewing.

54. The system of claim 53, wherein the number of viewers and the TV channel are obtained from the viewer.

55. The system of claim 53, wherein the information related to previous TV impressions further comprises:
a number of TVs that were turned on at the time slot; and
a channel that the TVs were tuned to at the time slot.

56. The system of claim 55, wherein the number of TVs and the channel is obtained from devices configured to provide TV services to a TV.

57. The system of claim 53, wherein the information related to previous TV impressions is collected by a telecast provider providing TV services to the viewers.

58. The system of claim 57, wherein the information related to previous TV impressions is augmented by information obtained from an external source.

59. The system of claim 45, wherein the information related to previous TV impressions is collected over a plurality of past weeks.

60. The system of claim 45, wherein the information related to programs comprises one or more of a listing of a plurality of TV channels, a schedule of content shown on each TV channel, a genre of the content, and advisory information related to the content.

61. The system of claim 60, wherein the listing and the schedule is obtained from an external source.

62. The system of claim 60, wherein the information comprises past schedules and future schedules.

63. The system of claim 45, wherein the means for predicting is configured to predict by processing the received previous TV impressions by a statistical technique, wherein the statistical technique accounts for a state of content in a future showing at the time slot on the TV channel.

64. The system of claim 63, wherein the statistical technique comprises averaging the received previous TV impressions.

65. The system of claim 63, wherein the state is determined by factors including one or more of new content, rerun of old content, a special event, and content shown on other TV channels.

66. The system of claim 45, further comprising:
means for receiving a previous TV impression at the time slot on the TV channel;
means for comparing the received TV impression to the predicted TV impression; and
means for adjusting future predictions based on the comparison.
